(19) United States
(12) Patent Application Publication
(10) Pub. No.: US 2008/0308126 A1
(43) Pub. Date: Dec. 18, 2008

(54) INSTALLATION FOR WASHING HAND TRUCKS OF OPERATING MACHINES, PARTICULARLY HAND TRUCKS OR ROTOGRAVURE MACHINES

(75) Inventor: Renzo MELOTTI, Sala Monferrato (IT)

Correspondence Address: OSTROLENK FABER GERB & SOFFEN, 1180 AVENUE OF THE AMERICAS, NEW YORK, NY, 100368403, US

(73) Assignee: BOBST Group Italia SpA

(21) Appl. No.: 12/135,889

(22) Filed: Jun. 9, 2008

Related U.S. Application Data
(62) Division of application No. 10/849,895, filed on May 21, 2004.

(30) Foreign Application Priority Data
May 29, 2003 (IT) TO-2003-A-000394

(51) Int. Cl. B08B 3/02

(52) U.S. Cl. 134/12; 134/26

(57) ABSTRACT

An installation for washing hand trucks of operating machines, particularly of rotogravure machines, is constructed and designed in order to receive and to treat in a wash chamber a whole hand truck along with all its parts, not dismounted. In the wash chamber of the installation there is a number of tubular bored bars which receive the wash solvent from a circulation pump and direct the same in the form of jets against the parts of the treated hand truck which require to be washed. The bars form a rotatable whole, are displaced in rotation and in translation in an alternate movement by pneumatic cylinders, and advantageously they surround a print cylinder mounted in the hand truck. A lower collecting basin receives the falling used solvent, and therefrom the solvent is sucked by the circulation pump during a first pre-wash step.

### CROSS-REFERENCE TO RELATED APPLICATIONS

This application is a divisional of application Ser. No. 10/849,895 filed May 21, 2004, the contents of which are specifically incorporated herein.

### BACKGROUND OF THE INVENTION

This invention refers to an installation for washing hand trucks of operating machines, and particularly intended for washing hand trucks of rotogravure machines.

According to the known technique, the hand trucks of rotogravure machines and other operating machines, after a pre-established working period, are taken out of the machine and are dismounted in the different component parts thereof. These parts are then washed by hand or in special installations, according to their size and to the their soiled state.

The parts to be washed by hand oblige the worker to make use of personal safety fittings, such as gloves, glasses and masks, and the parts to be washed in a washing installation require to be dismounted from the hand truck, charged in the washing installation and, at the end of the washing cycle, mounted again onto the hand truck. All these operations should necessarily be done by a worker. The consequences are relatively long operation times, noticeable industrial costs and a remarkable labour engagement.

### SUMMARY OF THE INVENTION

The object of the present invention is to make up, at all or in part, for the drawbacks and limits involved in the known technique now described. More particularly, a first object of the invention is to reduce the time needed for washing the hand trucks and for the connected operations. Another object of the invention is to reduce the labour engagement for washing the hand trucks. Still another object of the invention is to improve the recovery conditions of the solvent used for the washing operations.

The subject of the invention is an installation for washing the hand trucks of operating machines, mainly characterized in that it is constructed and designed in order to receive and to treat in a wash chamber a whole hand truck to be washed, along with all parts of the hand truck itself, not dismounted from the hand truck.

Thanks to this main characteristic, the installation allows to proceed to washing a hand truck without the need of any previous dismounting operation, and without needing any re-mounting operation of parts after the washing operation. Consequently, the operation time is radically reduced with respect to the time needed according to the known technique, and the labour engagement as well as the industrial costs are noticeably reduced.

This invention may find application to the washing of hand trucks purporting to any kind of operating machines, but its prevalent foreseen application is to the washing of hand trucks of rotogravure machines.

Advantageously, in the wash chamber of the installation there are provided a number of tubular bored bars, which receive a wash solvent coming from a circulation pump and direct the same in the form of jets against the hand truck, and especially onto the parts thereof which require to be washed in particular manner.

It is of advantage that said bars form a rotatable whole, displaced in rotation and in translation in an alternate movement, for example by pneumatic cylinders, whereby the bores of the bars direct a wash solvent flow towards the parts to be washed, along one or more directions, in connection with the position of each bar with respect to the hand truck. In the preferred application to the washing of hand trucks of rotogravure machines, it is of advantage that this rotatable whole surrounds the print cylinder mounted on the hand truck.

The installation comprises a lower collecting basin wherein falls the used solvent and wherefrom the solvent is sucked by the circulation pump during a first wash step (pre-wash cycle).

Moreover, the installation comprises a tank of clean solvent, wherefrom the solvent is sucked by the circulation pump during a final wash step.

Preferably the installation comprises a recuperation system for the used solvent, or a system of accumulation thereof for future recuperation, and comprises an empty pump intended for emptying the dirty solvent and the deposited sludge from the collection basin and for directing the same to the recuperation or accumulation system.

Advantageously the installation comprises a fan intended for exhausting the solvent vapors during all working steps and for directing the same to a condensation system, for the recirculation, recuperation, or store in view of a subsequent recuperation of the solvent.

### BRIEF DESCRIPTION OF THE DRAWINGS

The invention is described in the following with reference to an embodiment intended for washing hand trucks of rotogravure machines, this application being the typical one of the invention, however this embodiment is to be construed as a non limiting example. It is diagrammatically represented in the accompanying drawings, wherein:

FIG. 1 shows on a reduced scale a vertical longitudinal section of the installation according to the invention, in the open condition, and containing a hand truck of rotogravure machine.

FIG. 2 shows in plan view a horizontal section of the installation according to FIG. 1, this section being taken in correspondence with the axis of the rotatable whole of the tubular bars.

FIG. 3 shows in a plan view from outside of a portion of the installation according to FIG. 2.

FIGS. 4 and 5 show two vertical cross sections of the installation according to the foregoing Figures.

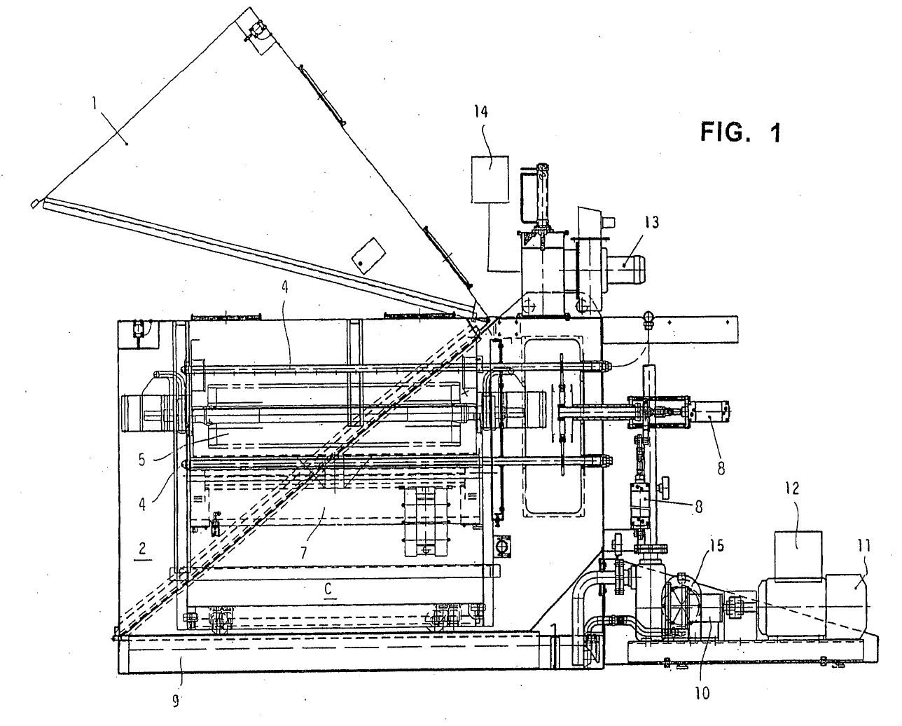

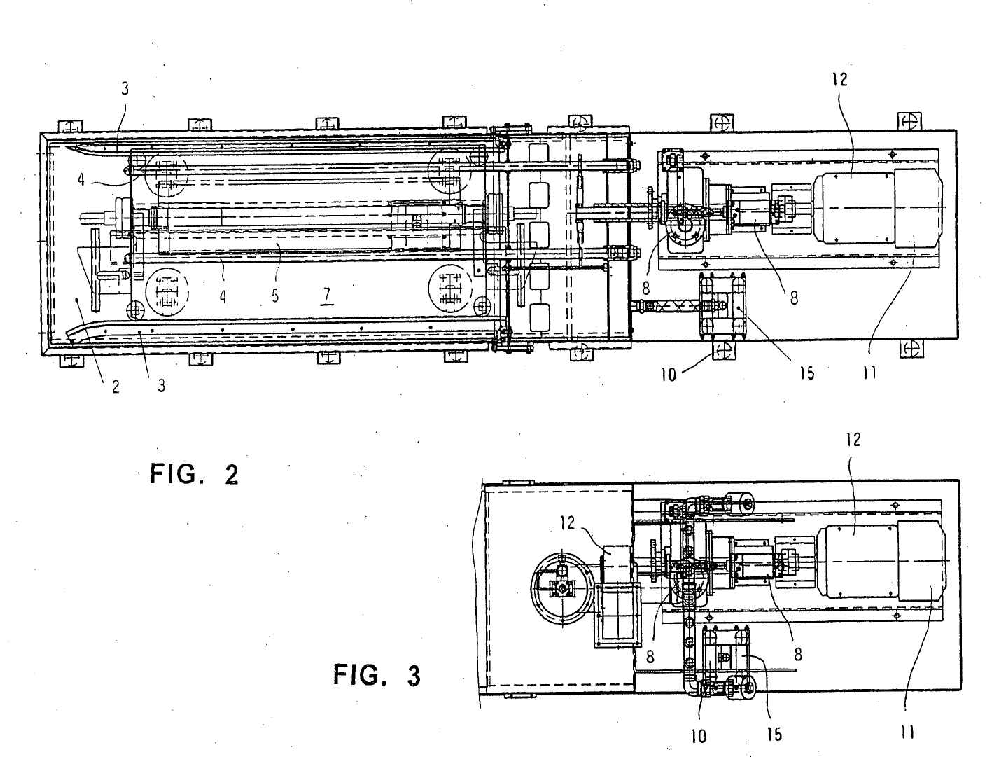

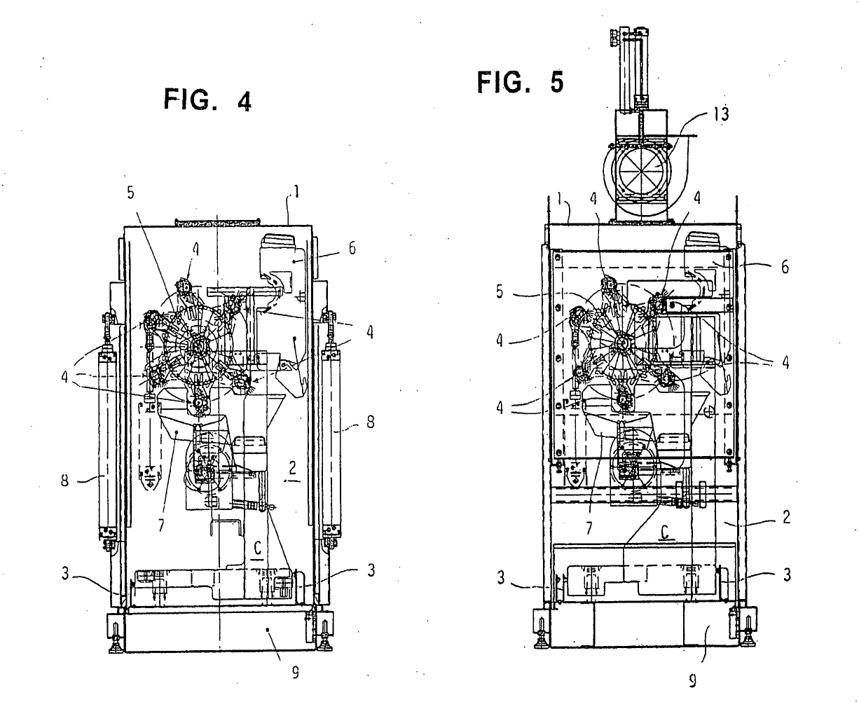

### DESCRIPTION OF THE PREFERRED EMBODIMENT

The installation comprises a wash chamber 2, whose size and conformation are suitable for receiving a hand truck C. The wash chamber 2 has a front opening through which the hand truck C may be introduced and extracted, and this opening can be closed by a door 1. Inside the wash chamber 2 there is a pair of guide members 3, between which is inserted the incoming hand truck C. This latter is then guided by the guide members 3, during its introduction, until a correct position for being washed.

Inside the wash chamber 2 are installed a number of tubular bored bars 4, which receive a wash solvent from a circulation pump 11 and direct the same in the form of jets onto the hand truck C, and especially onto the parts thereof that are to be particularly washed, namely (in the exemplified case) the print cylinder 5, the shelters 6 and the basin 7 of the hand truck. All the bars 4 form a rotatable whole which, in this case, is suitable for surrounding the print cylinder 5 mounted on the hand truck C, and this whole is displaced in rotation and in translation, with an alternate movement, by two pneumatic cylinders 8. The bores present on the bars 4 direct a wash solvent flow towards the parts to be washed, along one or more directions, in connection with the position of each bar 4 with respect to the hand truck C. The wash solvent thus used falls then in a lower collection basin 9, from which the used solvent can be sucked by the circulation pump 11.

The fact that the bars 4 are disposed around the print cylinder 5, and also between the print cylinder 5 and the basin 7 and between the print cylinder 5 and the shelters 6, allows the solvent jets to attain all regions of the hand truck that need to be washed. The wash efficiency is maximized because the bars are animated by an alternate movement, in rotation and in translation, so that they may ensure a complete cleaning.

A first wash step, constituting a pre-wash cycle, is effected by reusing the already used solvent present in the collection basin 9, recirculated by the circulation pump 11. Although already used, this solvent still has sufficient characteristics for effecting a first washing operation. After this pre-wash cycle is effected a final washing operation, or rinsing, by using clean solvent sucked by the circulation pump 11 from a special tank 12. During the whole wash cycle, and also when the door 1 is opened, a fan 13 is kept active in order to evacuate the vapors.

After a certain number of wash operations, the solvent present in the collection basin 9 becomes excessively dirty, and it needs to be replaced at least in part. To this aim serves an empty pump 10, inserted for emptying the dirty solvent and the deposited sludge from the collection basin 9. The sucked dirty solvent is then directed to a recuperation system, or to a store system 15 for subsequent recuperation. In this manner the recuperation operation takes place on solvent that, having repeatedly operated, contains a lot of substances to be eliminated, and therefore the operation is effected onto the minimal possible quantities of solvent, and it results economical. In effect, the cost of this operation substantially depends on the quantity of treated solvent, and not on the quantity of substances eliminated from the solvent.

Therefore, the operation of the installation according to the invention takes place according to the following cycle:

In a first step, the door 1 is opened and the hand truck C to be washed is introduced in the wash chamber 2.

In a second step, the door 1 is closed and the operation cycle is started by activating the circulation pump 11.

In a third step the used solvent, present in the collection basin 9, is recirculated by pump 11 in order to effect a pre-wash operation.

In a fourth step, clean solvent from tank 12 is circulated by the pump 11 in order to effect a final wash.

Finally, in a fifth step, the circulation of the solvent is stopped, the door 1 is opened and the washed hand truck C is extracted from the wash chamber 2.

During all the stated steps, by means of the fan 13 the solvent vapors are exhausted and directed towards a condensation device 14, for the recirculation, recuperation or accumulation in view of a subsequent recuperation of the solvent.

After a certain number of operation cycles, when the used solvent has attained a preestablished maximum level in the collection basin 9, the emptying of this collection basin 9 is effected by means of the pump 10, towards a recuperation device (which may work, for example, by means of distillation) or towards an accumulation tank 15, in view of a subsequent recuperation.

Thanks to the described features, several advantages may be exploited by the use of an installation according to the invention. Before all, the installation allows to wash a whole hand truck, rather than only some parts thereof, by introducing the hand truck directly in the wash installation. This also allows avoiding the operations of dismounting and then re-mounting the component parts of the hand truck, thus sparing time and labour and, after all, reducing the costs. Also advantageous is the fact of using as process fluid a solvent which can then be recovered by distillation in technically and economically optimal conditions.

Of course, different accessories may be added to the described installation, and various changes and replacements by technically equivalent means may be made, without departing from the spirit of the invention.

1. A method for washing hand trucks of operating machines, comprising:
opening a door of a washing chamber and introducing a hand truck of an operating machine to be washed into the washing chamber;
closing the door of the washing chamber;
activating a circulation pump to recirculate used washing solvent from a collection basin to pre-wash the hand truck;
circulating clean washing solvent by the circulation pump to effect a final wash of the hand truck; and
stopping circulation of the washing solvent, opening the door, and extracting the hand truck from the washing chamber.

2. A method for washing, as set forth in claim 1, further comprising receiving the washing solvent from the circulation pump communicating into the washing chamber via a plurality of tubular bored bars, and directing the washing solvent from the bars in the form of jets onto parts of hand truck which are to be washed.

3. A method for washing, as set forth in claim 2, wherein the bored bars form a rotatable and translatable whole, displacing the rotatable and translatable whole of the bored bars in rotation and in translation in an alternate movement, such that bored bars each direct a flow of the washing solvent toward the parts of the hand truck to be washed, along one or more directions, according to the position of each bored bar with respect to the hand truck.

4. A method for washing, as set forth in claim 1, further comprising collecting used solvent falling into the collection basin.

5. A method for washing, as set forth in claim 1, further comprising storing the clean washing solvent in a tank, and sucking the clean washing solvent from the tank by said circulation pump in the final wash step.

6. A method for washing, as set forth in claim 1, further comprising recuperating, or accumulating in view of future recuperating, the used washing solvent, and emptying from the collection basin dirty washing solvent and formed sludge and directing the dirty washing solvent for recuperation or accumulation.

7. A method for washing, as set forth in claim 1, further comprising exhausting vapors of the washing solvent during all steps of the method, and condensing the washing solvent vapors for recirculation, recuperation, or accumulation in view of future recuperation of the washing solvent.

8. A method for washing, as set forth in claim 1, wherein the operating machine is a rotogravure machine which includes a print cylinder mounted on the hand truck.
